(19) United States
(12) Patent Application Publication
(10) Pub. No.: US 2014/0044296 A1
(43) Pub. Date: Feb. 13, 2014

(54) AUDIBLE SOUNDS PLAY DEVICE CLIP ON TO SPOON AND FORK

(71) Applicant: Robert Joseph Baschnagel, III, Garden City, NY (US)

(72) Inventor: Robert Joseph Baschnagel, III, Garden City, NY (US)

(21) Appl. No.: 13/571,787

(22) Filed: Aug. 10, 2012

(51) Int. Cl. H04R 1/02

(52) U.S. Cl. 381/334

(57) ABSTRACT

The invention is a recording and playing device that can clip on to an eating utensil for example a fork or spoon for use by a parent or a child caregiver when feeding a child. The child is rewarded with a pleasing sound if he or she eats the food and punished with a negative sound if he or she does not eat the food. The device of the present invention may have various shapes from an airplane to a cartoon character so it can produce both visual and audio stimulation/entertaining effect to attract and maintain the interest of a child and encourage a child to eat more varieties of food.

### BACKGROUND OF THE INVENTION

1. Field of the Invention

This invention relates generally to a sound playing and recording device and more particularly to a sound playing and recording device that is in a shape of anything that can attract a child's attention and can clip on to a spoon or fork for use by a parent when feeding a child.

2. Description of Related Art

A lot of children start to become picky eaters around the age of two, developing a long term battle with food for many parents. It is common for children between the ages of 2 and 5 years old to fear new foods and resist eating new foods. They may just eat about four to five favorite foods that they already accept. Parents can be extremely stressed and frustrated by such behavior after trying many different approaches to encourage a child to eat a healthy diet including new foods but experiencing repetitive failures.

Although it can be frustrating when the child will only want to eat limited types of food, there are some effective ways that can help parents to encourage their child to eat new and more variety of food. One of the effective ways is to make eating food fun. Food can be introduced and given to children in creative and playful ways.

Therefore, there is a need for a device that can help parents and/or child caregivers have fun with children during snack or meal-time and thus are able to encourage children to eat more varieties of food.

### SUMMARY OF THE INVENTION

The invention is a recording and playing device that can clip on to an eating utensil for example a fork or spoon for use by a parent or a child caregiver when feeding a child. The child is rewarded with a pleasing sound if he or she eats the food and punished with a negative sound if he or she does not eat the food.

The utensil clip-on sound recording and playing device of the present invention may have various shapes from an airplane to a cartoon character so it can produce visual stimulation or entertaining effect to attract and maintain the interest of a child.

The device may have a cavity inside for holding the sound module for generating (playing) sound and/or recording sound, and a plurality of actuating switches such as buttons on its exterior surface. Two buttons are designed to be pushed for selectively actuating the sound module to produce audible sounds. If the child eats the food the parent can push the positive sound button and the device will make a pleasing sound. If the child does not eat the food pushing the negative sound button will produce an unpleasing sound.

The sound module of the device according to the present invention may be an analog recorder or a digital recorder. In one embodiment, the device may comprise a sound module including a memory for digitally storing a plurality of pre-recorded sound and a central processing unit for controlling operation of the sound module, a speaker for outputting audible sounds, and a power source such as a battery for providing electrical power to the sound module, speaker, and actuating switches. The positive and negative buttons are separately connected in wire with the sound module for selective control.

In one embodiment, the device has more features; it is able to record sounds that the parent or caregiver makes either for the positive or negative audio and playback such personal audio. The device may further comprise a microphone, and a hold-down button. When the parents or caregivers want to record the sound or message they hold down the button and to speak or record the sound into the microphone. The sound will then be stored in the sound module and played as desired.

In one embodiment, the sound recorder and player device is an analog recorder. The internal cavity of the device can hold two cassette tapes that are pre-recorded with different sounds and messages for play. One tape is used for storing pleasant sounds for reward and is connected with the positive button and the other tape is used for storing sounds for punishment and is connected with the negative button. Both tapes also allow parents and caregivers to record their own sounds and messages for reward and punishment.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a perspective view of an eating utensil clip-on sound recording and playing device according to an embodiment of the present invention.

FIG. 2 shows the bottom side of the recording device and in the center is a clip-on mechanism that will attach the recording device to a spoon or fork.

FIG. 3 shows the device and spoon in relation to how the two connect.

FIG. 4 shows the connected spoon and device.

FIG. 5 is a schematic view of the sound module in the device utilizing digital audio recording technology.

FIG. 6 is a schematic view of the analog recorder player in the device utilizing analog audio recording technology.

### DESCRIPTION OF THE PREFERRED EMBODIMENT

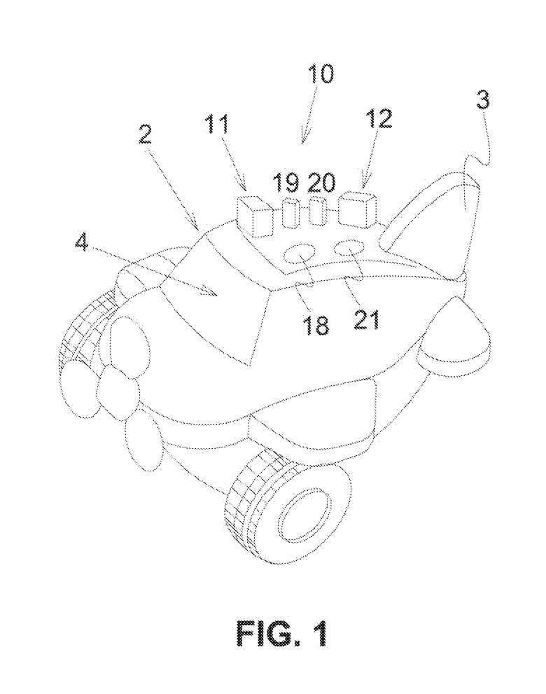

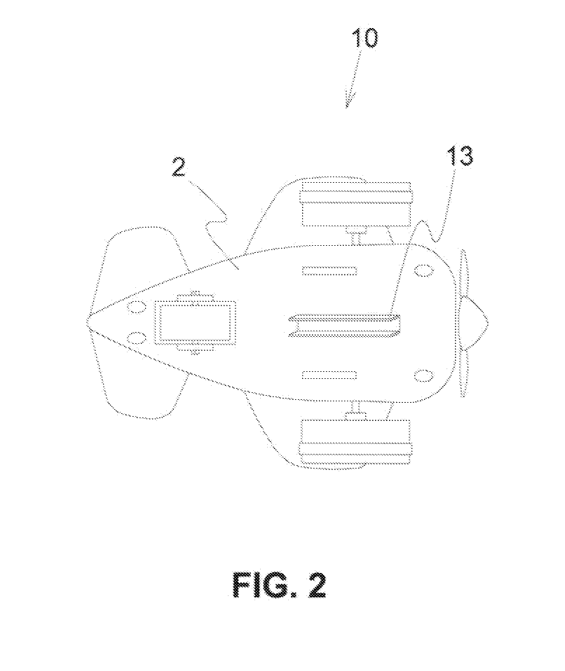

Referring to FIGS. 1 and 2, the present invention relates to a device that has a clip-on mechanism to clip on to an eating utensil such as a fork or spoon for use by a parent when feeding a child. The device generally indicated as 10 comprises a body 2 which can be in any shape or configuration from an airplane to a cartoon character that can attract a child's attention and maintain their interest during meal time. The body 2 has an exterior surface 3 and an internal cavity 4 for holding a sound module which can generate (play) sound effects to encourage a child to eat and a plurality of buttons 11, 12 for parents to selectively push and play the sound. The child is rewarded with a pleasing sound if he or she eats the food and punished with a negative sound if he or she does not eat the food.

Referring to FIG. 1 there is disclosed a clip-on recorder and player device 10 in a shape of an airplane according to an embodiment of the present invention. There are two buttons 11, 12 on the top of the device 10. If the child eats the food the parent can push the positive button 11 and the device 10 will make a pleasing sound. If the child does not eat the food pushing the negative button 12 will produce an unpleasing sound.

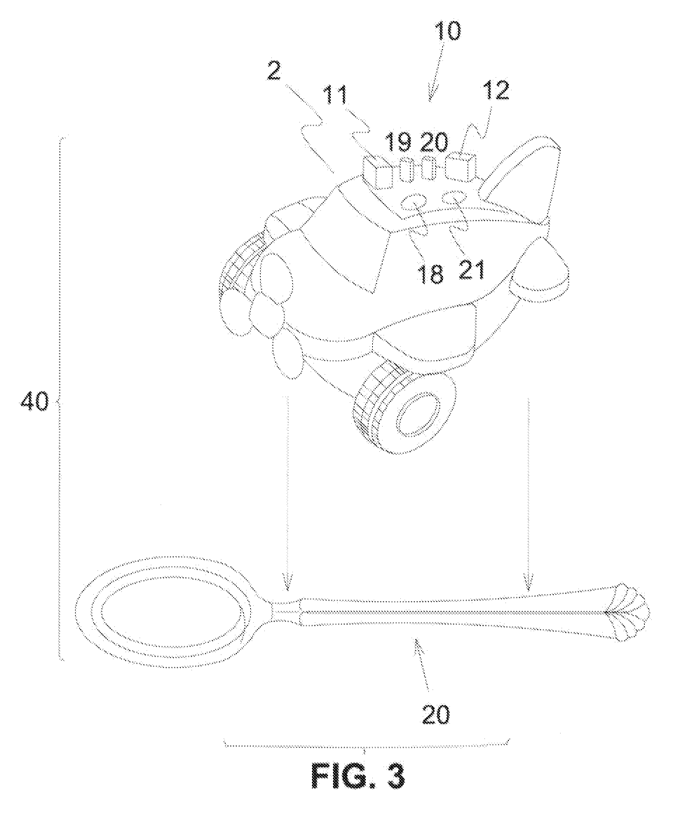

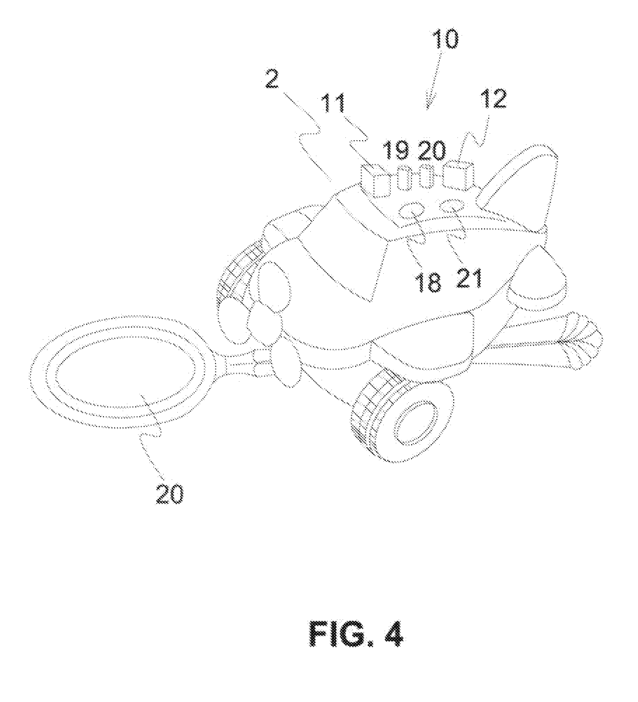

FIG. 2 shows the bottom side of the recording device 10 where in the center is a clip-on mechanism 13 that will attach the recording device 10 to an eating utensil 20 such as a spoon or fork. The size and shape of the clip-on mechanism 13 may vary to adapt to various sizes of spoons and forks 20. Using a spoon as an example, FIG. 3 shows the device 10 and spoon 20 in relation to how the two connect and FIG. 4 shows the connected spoon 20 and device 10. The body 2 of the device 10 is made of plastic, preferably manufactured by molding process. Other materials suitable may also be used to make the body 2. The internal cavity 4 may be permanently sealed or can be opened and closed by a latch. The device 10 may further comprise record button(s) 19, 20 and a speaker 18 and microphone 21.

The sound module 14 of the device 10 according to the present invention may be analog audio recorder or a digital audio recorder.

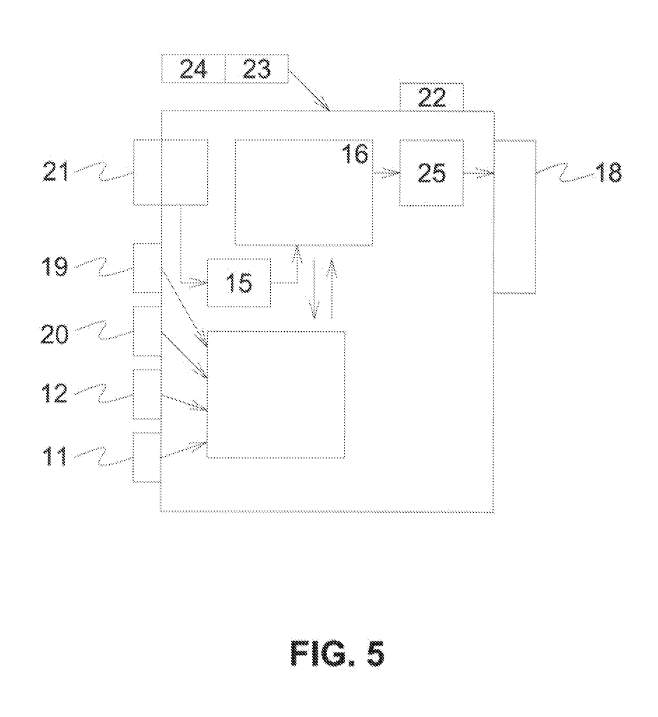

Referring to FIG. 5, there is disclosed a schematic view of the sound module generally designated as 14 for producing sound which may comprise, a memory 16 for storing pre-recorded audio files, a microprocessor 17 or central processing unit (CPU) for controlling operation of the sound module 14 and analog-to-digital converter (ADC) 15 and digital-to-analog converter (DAC) 25. The sound module 14 further comprises a speaker 18 for outputting sounds. The sound module 14 is connected to the user interface such as push to play buttons 11 and 12 disclosed in FIG. 1 so that a user can selectively play the sounds. The user interface may include record buttons 19, 20 or stop button(s) like other typical audio recorder provides. The rewarding sounds and punishment sounds may be stored separately in the memory 16. By pushing the positive button 11, the microprocessor 17 or CPU will retrieve rewarding sound's audio file from the memory 16 and sound module 14 will convert the digital audio file to analog using DAC 25 and produce the pleasing sound through the speaker 18 to reward a child. By pushing the negative button, the microprocessor 17 will retrieve negative sound's audio file from the memory 16 and sound module 14 will convert the digital data to analog using DAC 25, and produce the negative sound through the speaker 18 to punish a child.

In another embodiment, the sound module 14 and user interface may have even more complex design. The device 10 may be enabled to allow for selecting a particular audio file for a reward or punishment.

In another embodiment, the device 10 has more features and is able to record sounds that the parent makes either for the positive or negative audio files and playback such personal audio files. The device 10 may further comprise two record buttons 19, 20 and a microphone 21. The record buttons 19 and 20 are connected to microprocessor 17 or CPU to actuate the recording process and the microphone 21 receives the user's personal analog sound signal. The sound module 14 then converts the analog sound signal to a digital form by a process of digitization using ADC 15, and stores the digitized signal in the memory 16. Pushing down the record button 19 will trigger the sound module 14 to save the audio file as a pleasing sound. Pushing down the record button 20 will trigger the sound module 14 to save the audio file as a negative punishment sound. The audio file may be stored in any of a variety of digital audio formats known to those skilled in the art.

The sound module 14 may be a universal serial bus (USB) direct sound module which allows a user to program their own music and create sound that they need. The device further comprises a USB connector 22 and an interface. The user can re-program the sound module by connecting the sound module to a computer and download the sound file from a website.

The device 10 further comprises a power supply source which may be a battery 23 for providing electrical power to the device 10 including sound module 14. The device 10 further comprises a recharger 24 to charge the battery from an external power supply.

The method of or arrangement of wiring or connecting the above electronic components and mounting them will be well known to those with ordinary skill in the electronic and mechanical arts.

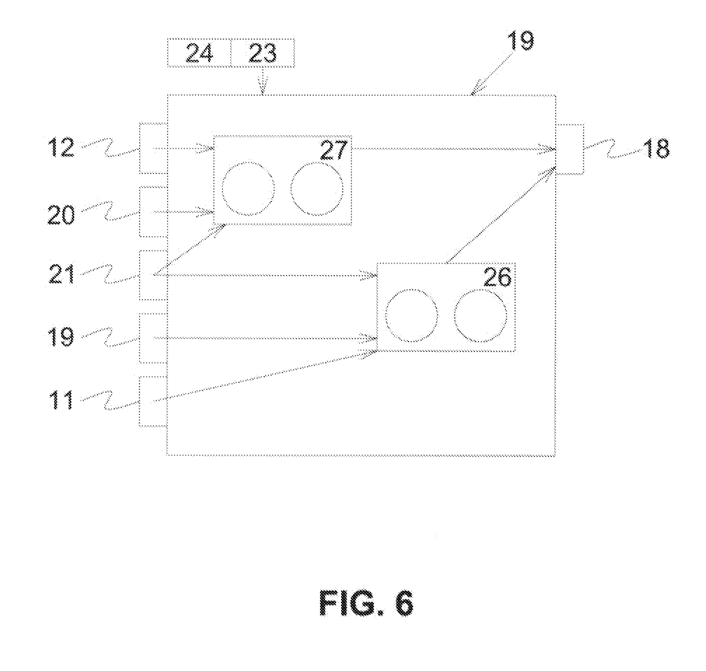

In another embodiment, the device 10 contains an analog recorder 19 in its cavity. Referring to FIG. 6, there is disclosed a part of device 10 which holds two cassette tape players 26, 27 that are pre-recorded with different sounds or messages for play. The first tape 26 is used to store pre-recorded pleasing sounds for reward and is connected with the positive button 11 and the second tape 27 is used to store pre-recorded sounds for punishment and is connected with the negative button 12. By pressing the positive button lithe speaker 18 will produce a pleasing sound to reward a child; by pressing the negative button 12 the speaker 18 will produce a negative sound to punish a child. Both tapes 26, 27 also allow parents and caregivers to record their own sounds and messages for reward and punishment. The device comprises a microphone 21 and two record buttons 19, 20. The first said record button 19 is connected to the first cassette tape 26 and a second record button 20 is connected to the second cassette tape 27. wherein by pressing said first record button 19 a user can speak into the microphone 21 and record message into the first cassette tape 26, by pressing the second record button 20 a user can speak into the microphone 21 and record message into the second cassette tape 27. The device 10 further comprises a power supply source which may be a battery 23 for providing electrical power to the device 10. The device 10 further comprises a recharger 24 to charge the battery from an external power supply.

The method of or arrangement of wiring or connecting the above electronic components and mounting them will be well known to those with ordinary skill in the electronic and mechanical arts.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A spoon or fork clip-on sound producing device comprising:
a sound module for generating sound effects, said sound module including a speaker for outputting audible sounds;
a body having a given configuration and visual appearance of anything that can attract a child's attention, said body having an exterior surface, a cavity for holding said sound module, and a clip-on mechanism located on said exterior surface that can attach said device to a spoon or fork;
a positive button located on said exterior surface of said body and connected to said sound module for actuating said sound module to generate a pleasing sound for rewarding a child; and
a negative button located on said exterior surface of said body and connected to said sound module for actuating said sound module to generate a negative sound for punishing a child.

2. The device of claim 1 wherein said sound module may further comprise a microprocessor or a central processing unit.

3. The device of claim 2 wherein said sound module may further comprise a digital data memory storage.

4. The device of claim 3 further comprises a microphone and a first and second record buttons, both record buttons are connected to said sound module, wherein by pressing said first record button a user can make sound signals into said microphone said sound module will record and save said sound signals as a pleasing rewarding sound audio file, by pressing said second record button a user can make sound signals into said microphone said sound module will record and save said sound signals as a negative punishment sound audio file.

5. The device of claim 4 further comprises a battery for providing electricity to said device.

6. The device of claim 5 further comprises a battery recharging unit for charging said battery from an external electrical power source.

7. The device of claim 1 further comprises a USB connector which is electrically connected to said sound module.

8. The device of claim 1 further comprises a first and second cassette tapes, said first cassette tape connected to said positive button is stored with pre-recorded pleasing sound, said second cassette tape connected to said negative button is stored with pre-recorded negative sounds, wherein by pressing said positive button said speaker will produce a pleasing sound to reward a child, by pressing said negative button said speaker will produce a negative sound to punish a child.

9. The device of claim 8 further comprises a microphone and a first and second record buttons, said first record button connected to said first cassette tape and said second record button connected to said second cassette tape, wherein by pressing said first record button a user can speak into said microphone and record message into said first cassette tape, by pressing said second record button a user can speak into said microphone and record message into said second cassette tape.

10. The device of claim 1 wherein said clip-on mechanism varies in size and shape and is adapted to fit most of spoons and forks.

11. The device of claim 1 wherein said body is made of plastic, preferably, manufactured by molding process.

12. The device of claim 9 further comprises a battery for providing electricity to said device, and battery recharging unit for charging said battery from an external electrical power source.

13. A spoon or fork clip-on sound producing device comprising:
a sound module for generating sound effects, said sound module including a speaker for outputting audible sounds, a microprocessor or a central processing unit and a digital data memory storage;
a body having a given configuration and visual appearance of anything that can attract a child's attention, said body having an exterior surface, a cavity for holding said sound module, and a clip-on mechanism which is located on said exterior surface that can attach said device to a spoon or fork;
a positive button located on said exterior surface of said body and connected to said sound module for actuating said sound module to generate a pleasing sound for rewarding a child; and
a negative button located on said exterior surface of said body and connected to said sound module for actuating said sound module to generate a negative sound for punishing a child.

14. The device of claim 13 further comprises a microphone and a first and second record buttons, both record buttons are connected to said sound module, wherein by pressing said first record button a user can make sound signals into said microphone said sound module will record and save said sound signals as a pleasing rewarding sound audio file, by pressing said second record button a user can make sound signals into said microphone said sound module will record and save said sound signals as a negative punishment sound audio file.

15. The device of claim 14 further comprises a battery for providing electricity to said device, and battery recharging unit for charging said battery from an external electrical power source.

16. The device of claim 15 further comprises a USB connector which is electrically connected to said sound module.

17. The device of claim 16 wherein said clip-on mechanism varies in size and shape and is adapted to fit most of spoons and forks.

18. The device of claim 13 wherein said body is made of plastic, preferably, manufactured by molding process.
